(19) United States
(12) Patent Application Publication
(10) Pub. No.: US 2021/0250489 A1
(43) Pub. Date: Aug. 12, 2021

(54) CAMERA SYSTEM FOR VEHICLE

(71) Applicant: Samsung Electro-Mechanics Co., Ltd., Suwon-si (KR)

(72) Inventor: Seok June HONG, Suwon-si (KR)

(73) Assignee: Samsung Electro-Mechanics Co., Ltd., Suwon-si (KR)

(21) Appl. No.: 16/994,780

(22) Filed: Aug. 17, 2020

(30) Foreign Application Priority Data
Feb. 6, 2020 (KR) 10-2020-0014408

(51) Int. Cl. H04N 5/232; H04N 5/225; B60R 11/04

(52) U.S. Cl. CPC H04N 5/23203; H04N 5/2253; B60R 11/04; H04N 5/2252; H04N 5/23212; H04N 5/2254

(57) ABSTRACT

A camera system for a vehicle includes: a side view camera apparatus including a left side view camera and a right side view camera; a top view camera apparatus including a left top view camera and a right top view camera; an electronic controller configured to receive images from the side view camera apparatus and the top view camera apparatus; and a display apparatus configured to receive, from the electronic controller, the images from the side view camera apparatus and the top view camera apparatus, and output the images from the side view camera apparatus and the top view camera apparatus. The electronic controller is further configured to change an imaging angle of either one or both of the left top view camera and the right top view camera, in response to either one or both of the left side view camera and the right side view camera failing.

### CROSS-REFERENCE TO RELATED APPLICATIONS

This application claims the benefit under 35 U.S.C. § 119(a) of Korean Patent Application No. 10-2020-0014408 filed on Feb. 6, 2020 in the Korean Intellectual Property Office, the entire disclosure of which is incorporated herein by reference for all purposes.

### BACKGROUND

### 1. Field

The following description relates to a camera system for a vehicle.

### 2. Description of Related Art

Recently, in order to prevent an accident occurring due to a blind spot in driving and parking a vehicle, a plurality of top view cameras for providing an image of the vehicle viewed in a downward direction from a point in space above the vehicle have been mounted on the vehicle. In addition, in order to replace side mirrors of a vehicle, which are susceptible to resistance during driving or susceptible to external shock, a plurality of side view cameras have been mounted on the vehicle. However, when one or more cameras among the plurality of top view cameras and the plurality of side view cameras fails, a driver may not be able to acquire information on an image provided from the failed camera(s), thereby causing a problem and increasing a risk of an accident.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera system for a vehicle includes: a side view camera apparatus including a left side view camera and a right side view camera; a top view camera apparatus including a left top view camera and a right top view camera; an electronic controller configured to receive images from the side view camera apparatus and the top view camera apparatus; and a display apparatus configured to receive, from the electronic controller, the images from the side view camera apparatus and the top view camera apparatus, and output the images from the side view camera apparatus and the top view camera apparatus. The electronic controller is further configured to change an imaging angle of either one or both of the left top view camera and the right top view camera, in response to either one or both of the left side view camera and the right side view camera failing.

The electronic controller may be further configured to change the imaging angle of the left top view camera to correspond to an imaging angle of the left side view camera, in response to the left side view camera failing, and change an imaging angle of the right top view camera to correspond to the imaging angle of the right side view camera, in response to the right side view camera failing.

The electronic controller may be further configured to replace an image from the left side view camera with an image from the left top view camera, in response to the left side view camera failing, and replace an image from the right side view camera with an image from the right top view camera, in response to the right side view camera failing.

The camera system may further include an angle-adjusting apparatus configured to adjust the imaging angle of the left top view camera and the imaging angle of the right top view camera.

The left side view camera and the left top view camera may be mounted on a first housing. The right side view camera and the right top view camera may be mounted on a second housing. The angle-adjusting apparatus may be further configured to adjust the imaging angle of the left top view camera by rotating the first housing, and adjust the imaging angle of the right top view camera by rotating the second housing.

The electronic controller may be further configured to change the imaging angle of either one or both of the left top view camera and the right top view camera to capture images in a rear direction of the vehicle, in response to either one or both of the left side view camera and the right side view camera failing.

The electronic controller may be further configured to determine that either one or both of the left side view camera and the right side view camera has failed, in response to an image not being received from either one or both of the left side view camera and the right side view camera for a reference time period.

The electronic controller may be further configured to determine that either one or both of the left side view camera and the right side view camera has failed, according to an interrupt signal generated by driving an interrupt switch.

The top view camera apparatus may further include a front top view camera and a rear top view camera.

In another general aspect, a camera system for a vehicle includes: a side view camera apparatus including a left side view camera and a right side view camera; a top view camera apparatus including a left top view camera and a right top view camera; an electronic controller configured to receive images provided from the side view camera apparatus and the top view camera apparatus; and a display apparatus configured to receive, from the electronic controller, the images from the side view camera apparatus and the top view camera apparatus, and output the images from the side view camera apparatus and the top view camera apparatus. The electronic controller is further configured to change an imaging angle of either one or both of the left side view camera and the right side view camera, in response to either one or both of the left top view camera and the right top view camera failing.

The electronic controller may be further configured to change the imaging angle of the left side view camera to correspond to an imaging angle of the left top view camera, in response to the left top view camera failing, and change the imaging angle of the right side view camera to correspond to an imaging angle of the right top view camera, in response to the right top view camera failing.

The electronic controller may be further configured to replace an image from the left top view camera with an image from the left side view camera, in response to the left top view camera failing, and replace an image from the right top view camera with an image from the right side view camera, in response to the right top view camera failing.

The camera system may further include an angle-adjusting apparatus configured to adjust the imaging angle of the left side view camera and the imaging angle of the right side view camera.

The left side view camera and the left top view camera may be mounted on a first housing. The right side view camera and the right top view camera may be mounted on a second housing. The angle-adjusting apparatus be further configured to adjust the imaging angle of the left side view camera by rotating the first housing, and adjust the imaging angle of the right side view camera by rotating the second housing.

The controller may be further configured to change the imaging angle of either one or both of the left side view camera and the right side view camera to capture images in a downward direction of the vehicle, in response to either one or both of the left top view camera and the right top view camera failing.

The electronic controller may be further configured to determine that either one or both of the left top view camera and the right top view camera has failed, in response to an image not being received from either one or both of the left top view camera and the right top view camera for a reference time period.

The electronic controller may be further configured to determine that either one or both of the left top view camera and the right top view camera has failed, according to an interrupt signal generated by driving an interrupt switch.

The top view camera apparatus may further include a front top view camera and a rear top view camera.

Other features and aspects will be apparent from the following detailed description, the drawings, and the claims.

### BRIEF DESCRIPTION OF DRAWINGS

FIG. 1 is a block diagram of a camera system for a vehicle, according to an embodiment.

FIG. 2 is a view illustrating a display apparatus, according to an embodiment.

FIG. 3 is a view illustrating the left side view camera and the right left top view camera of FIG. 1.

FIG. 4 is a view illustrating an angle-adjusting apparatus, according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

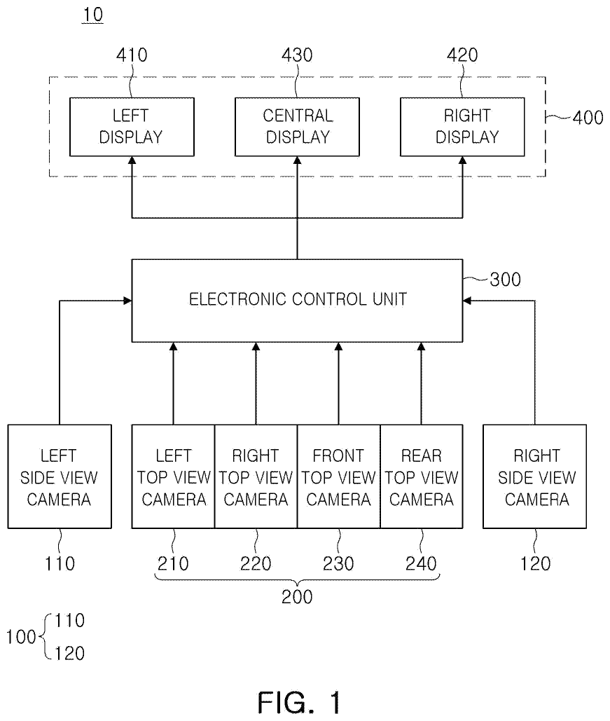

FIG. 1 is a block diagram of a camera system 10 for a vehicle, according to an embodiment.

Referring to FIG. 1, a camera system 10 for a vehicle, according to an embodiment of the present disclosure, may include a side view camera apparatus 100, a top view camera apparatus 200, an electronic control unit (ECU) or electronic controller 300, and a display apparatus 400.

The side view camera apparatus 100 may include a left side view camera 110 configured to perform imaging in a left rear direction of the vehicle, and a right side view camera 120 configured to perform imaging in a right rear direction of the vehicle. Each of the left side view camera 110 and the right side view camera 120 may include a narrow angle camera that provides relatively high image quality and relatively high sense of distance.

The top view camera apparatus 200 may include a left top view camera 210 configured to perform imaging in a leftward direction of the vehicle, a right top view camera 220 configured to perform imaging in a rightward direction of the vehicle, a front top view camera 230 configured to perform imaging in a front direction of the vehicle, and a rear top view camera 240 configured to perform imaging in a rear direction of the vehicle.

As an example, the left top view camera 210, the right top view camera 220, the front top view camera 230, and the rear top view camera 240 may respectively capture images in respective downward directions, e.g., in respective ground-facing directions, from respective left, right, front, and rear external spaces of the vehicle.

Each of the left top view camera 210, the right top view camera 220, the front top view camera 230, and the rear top view camera 240 may include a wide angle camera.

The electronic control unit 300 may receive images output from the left side view camera 110, the right side view camera 120, the left top view camera 210, the right top view camera 220, the front top view camera 230, and the rear top view camera 240. The electronic control unit 300 may provide the received images to the display apparatus 400.

The electronic control unit 300 may include a semiconductor processor that performs overall control of the left side view camera 110, the right side view camera 120, the left top view camera 210, the right top view camera 220, the front top view camera 230, and the rear top view camera 240.

The display apparatus 400 may include a left display 410, a right display 420, and a central display 430.

The electronic control unit 300 may provide an image received from the left side view camera 110 to the left display 410, and may provide an image received from the right side view camera 120 to the right display 420. For example, the electronic control unit 300 may convert the images received from the left side view camera 110 and the right side view camera 120 into electronic mirror images, and may provide the electronic mirror images to the left display 410 and the right display 420 respectively.

The electronic control unit 300 may provide images from the left top view camera 210, the right top view camera 220, the front top view camera 230, and the rear top view camera 240 to the central display 430.

For example, the electronic control unit 300 may synthesize images from the left top view camera 210, the right top view camera 220, the front top view camera 230, and the rear top view camera 240, to generate top view images, for example, such that a driver looks at the vehicle in a downward direction from a point in space above the vehicle, and may provide the generated top view image to the central display 430.

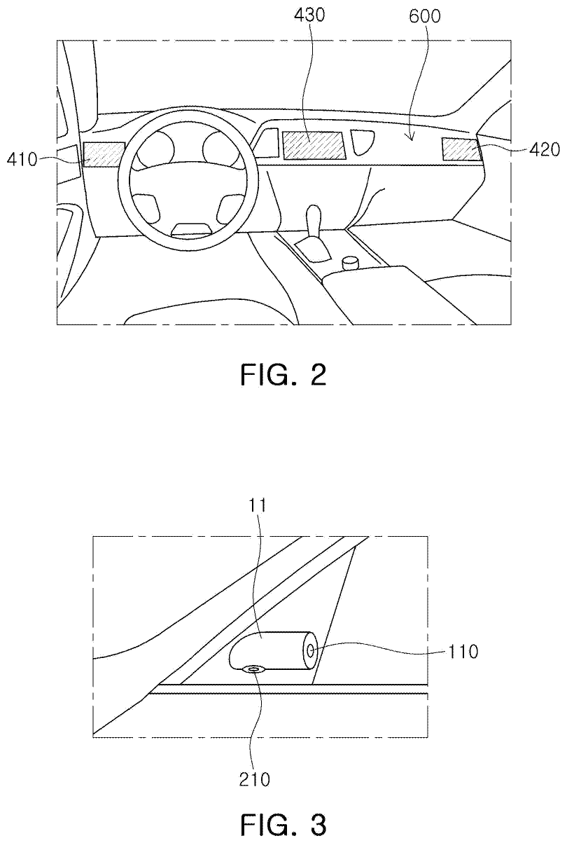

FIG. 2 is a view illustrating the display apparatus 400, according to an embodiment.

Referring to FIG. 2, a left display 410 and a right display 420 may be installed in left and right end portions of a dashboard 600 inside a vehicle, respectively, to output electronic mirror images, based on a left side view camera 110 and a right side view camera 120, respectively. Therefore, the left display 410 and the right display 420 may assist a driver to drive the vehicle while monitoring in rear leftward and rightward directions of the vehicle.

The central display 430 may be installed in a central portion of the dashboard 600 inside the vehicle, to output top view images, based on the left top view camera 210, the right top view camera 220, the front top view camera 230, and the rear top view camera 240. The central display 430 may output top view images, for example, such that the driver views the vehicle in a downward direction from a point in space above the vehicle, to assist the driver in driving the vehicle.

FIG. 3 is a view illustrating the left side view camera 110 and the left top view camera, according to an embodiment.

Referring to FIG. 3, the left side view camera 110 and the left top view camera 210 may be respectively installed in a housing 11 mounted on a left external side of a vehicle. The left side view camera 110 may capture images in a rear direction from the left external side of the vehicle, and the left top view camera 210 may capture images in a downward direction from the left external side of the vehicle.

Similarly, the right side view camera 120 and a right top view camera 220 may be respectively installed in a housing 11 mounted on a right external side of the vehicle. The right side view camera 120 may capture images in a rear direction from the right external side of the vehicle, and the right top view camera 220 may capture images in a downward direction from the right external side of the vehicle.

In addition, the front top view camera 230 and the rear top view camera 240 may be respectively installed on front and rear external sides of the vehicle, to capture images in a downward direction from front and rear external sides of the vehicle, respectively.

The camera system 10 may provide an electronic mirror image and a top view image to a driver to remove a blind spot. When the left side view camera 110 and the right side view camera 120 fail, the electronic mirror image may not be provided, and there may be thus a problem that the driver's accident risk is greatly increased.

When either one or both of the left side view camera 110 and the right side view camera 120 fails, the electronic control unit 300 may change an imaging angle of either one or both of the left top view camera 210 and the right top view camera 220.

For example, the electronic control unit 300 may change an imaging angle of the left top view camera 210 corresponding to the left side view camera 110, when the left side view camera 110 fails, and may change an imaging angle of the right top view camera 220 corresponding to the right side view camera 120, when the right side view camera 120 fails.

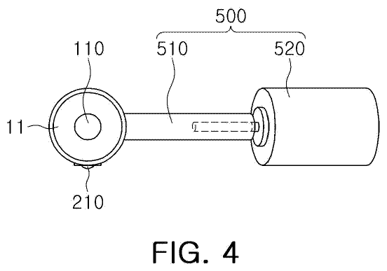

The camera system 10 may further include an angle-adjusting apparatus 500 (FIG. 4) configured to change an imaging angle of either one or both of the left top view camera 210 and the right top view camera 220, when either one or both of the left side view camera 110 and the right side view camera 120 fails.

FIG. 4 is a view illustrating the angle-adjusting apparatus 500, according to an embodiment.

Referring to FIG. 4, an angle-adjusting apparatus 500 may include a rotating shaft 510 connected to the housing 11, and a motor 520 connected to the rotating shaft 510 and configured to rotate the rotating shaft 510. When the motor 520 rotates in one direction or in another direction opposite to the one direction under control of the electronic control unit 300, and thereby rotates the rotating shaft 510 and the housing 11 in the one direction or the other direction, imaging angles of the left side view camera 110 and the left top view camera 210 may be changed.

Similarly to the left side view camera 110 and the left top view camera 210, the right side view camera 120 and the right top view camera 220 may be installed in a housing 11 connected to an angle-adjusting apparatus 500. That is, respective housings 11 may be connected to respective angle-adjusting apparatuses 500.

For example, when either one or both of the left side view camera 110 and the right side view camera 120 fails, the electronic control unit 300 may control the respective motor(s) 520 to change an imaging angle of either one or both of the left top view camera 210 and the right top view camera 220 to capture images in a rear direction of the vehicle.

When an image is not received from either one or both of the left side view camera 110 and the right side view camera 120 for a reference time period, the electronic control unit 300 may determine that either one or both of the left side view camera 110 and the right side view camera 120 has failed, to control the angle-adjusting apparatus 500.

Also, the electronic control unit 300 may determine that either one or both of the left side view camera 110 and the right side view camera 120 has failed, according to an interrupt signal, to control the angle-adjusting apparatus 500.

For example, the interrupt signal may be provided by an interrupt switch that operates according to driving of a user. The interrupt switch may include two interrupt switches respectively corresponding to the left side view camera 110 and the right side view camera 120, to distinguish the left side view camera 110 and the right side view camera 120.

When the left side view camera 110 fails, the electronic control unit 300 may replace an image from the failed left side view camera 110 with an image from the left top view camera 210 of which an imaging angle is changed to capture images in a rear direction of the vehicle, to generate an electronic mirror image. When the right side view camera 120 fails, the electronic control unit 300 may replace an image from the failed right side view camera 120 with an image from the right top view camera 220 of which an imaging angle is changed to capture images in a rear direction of the vehicle, to generate an electronic mirror image.

When either one or both of the left side view camera 110 and the right side view camera 120 fails, the electronic control unit 300 may change an imaging angle of either one or both of the left top view camera 210 and the right top view camera 220, to significantly reduce a risk of an accident.

The above-described embodiments may change the imaging angle of the left top view camera 210 or the right top view camera 220, when the left side view camera 110 or the right side view camera 120 fails. According to an embodiment, the imaging angle of the left side view camera 110 or the right side view camera 120 may be changed to capture images in a downward direction by the previously described rotation of the motor 520, when the left top view camera 210 or the right top view camera 220 fails.

According to embodiments described herein, a camera system for a vehicle may change an imaging angle of one camera among a top view camera and a side view camera when another camera among the top view camera and the side view camera fails, to reduce a risk of an accident.

The electronic control unit 300, the display apparatus 400, the left display 410, the central display 420, and the right display 430 in FIGS. 1 to 4 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. In addition, respective embodiments may be combined with each other. For example, the pressing members disclosed in the above-described embodiments may be used in combination with each other in one force sensing device. Therefore, the scope of the disclosure is defined not by the detailed description, but by the claims and their equivalents, and all variations within the scope of the claims and their equivalents are to be construed as being included in the disclosure.

1. A camera system for a vehicle, comprising:
a side view camera apparatus including a left side view camera and a right side view camera;
a top view camera apparatus including a left top view camera and a right top view camera;
an electronic controller configured to receive images from the side view camera apparatus and the top view camera apparatus; and
a display apparatus configured to receive, from the electronic controller, the images from the side view camera apparatus and the top view camera apparatus, and output the images from the side view camera apparatus and the top view camera apparatus,
wherein the electronic controller is further configured to:
change an imaging angle of either one or both of the left top view camera and the right top view camera, in response to either one or both of the left side view camera and the right side view camera failing; and
change an imaging angle of either one or both of the left side view camera and the right side view camera, in response to either one or both of the left top view camera and the right top view camera failing.

2. The camera system of claim 1, wherein the electronic controller is further configured to change the imaging angle of the left top view camera to correspond to the imaging angle of the left side view camera, in response to the left side view camera failing, and change the imaging angle of the right top view camera to correspond to the imaging angle of the right side view camera, in response to the right side view camera failing.

3. The camera system of claim 2, wherein the electronic controller is further configured to replace an image from the left side view camera with an image from the left top view camera, in response to the left side view camera failing, and replace an image from the right side view camera with an image from the right top view camera, in response to the right side view camera failing.

4. The camera system of claim 1, further comprising rotatable members configured to adjust the imaging angle of the left top view camera and the imaging angle of the right top view camera.

5. The camera system of claim 4, wherein the left side view camera and the left top view camera are mounted on a first housing,
wherein the right side view camera and the right top view camera are mounted on a second housing, and
wherein the rotatable members are further configured to adjust the imaging angle of the left top view camera by rotating the first housing, and adjust the imaging angle of the right top view camera by rotating the second housing.

6. The camera system of claim 1, wherein the electronic controller is further configured to change the imaging angle of either one or both of the left top view camera and the right top view camera to capture images in a rear direction of the vehicle, in response to either one or both of the left side view camera and the right side view camera failing.

7. The camera system of claim 1, wherein the electronic controller is further configured to determine that either one or both of the left side view camera and the right side view camera has failed, in response to an image not being received from either one or both of the left side view camera and the right side view camera for a reference time period.

8. The camera system of claim 1, wherein the electronic controller is further configured to determine that either one or both of the left side view camera and the right side view camera has failed, according to an interrupt signal generated by driving an interrupt switch.

9. The camera system of claim 1, wherein the top view camera apparatus further comprises a front top view camera and a rear top view camera.

10. A camera system for a vehicle, comprising:
a side view camera apparatus including a left side view camera and a right side view camera;
a top view camera apparatus including a left top view camera and a right top view camera;
an electronic controller configured to receive images from the side view camera apparatus and the top view camera apparatus; and
a display apparatus configured to receive, from the electronic controller, the images from the side view camera apparatus and the top view camera apparatus, and output the images from the side view camera apparatus and the top view camera apparatus,
wherein the electronic controller is further configured to:
change an imaging angle of either one or both of the left side view camera and the right side view camera, in response to either one or both of the left top view camera and the right top view camera failing; or
change an imaging angle of either one or both of the left top view camera and the right top view camera, in response to either one or both of the left side view camera and the right side view camera failing, and
wherein the electronic controller is further configured to:
determine that either one or both of the left side view camera and the right side view camera has failed, according to an interrupt signal generated by an interrupt switch driven by a user; or
determine that either one or both of the left top view camera and the right top view camera has failed, according to another interrupt signal generated by another interrupt switch driven by the user.

11. The camera system of claim 10, wherein the electronic controller is further configured to change the imaging angle of the left side view camera to correspond to the imaging angle of the left top view camera, in response to the left top view camera failing, and change the imaging angle of the right side view camera to correspond to the imaging angle of the right top view camera, in response to the right top view camera failing.

12. The camera system of claim 11, wherein the electronic controller is further configured to replace an image from the left top view camera with an image from the left side view camera, in response to the left top view camera failing, and replace an image from the right top view camera with an image from the right side view camera, in response to the right top view camera failing.

13. The camera system of claim 10, further comprising rotatable members configured to adjust the imaging angle of the left side view camera and the imaging angle of the right side view camera.

14. The camera system of claim 13, wherein the left side view camera and the left top view camera are mounted on a first housing,
wherein the right side view camera and the right top view camera are mounted on a second housing, and
wherein the rotatable members are further configured to adjust the imaging angle of the left side view camera by rotating the first housing, and adjust the imaging angle of the right side view camera by rotating the second housing.

15. The camera system of claim 10, wherein the electronic controller is further configured to change the imaging angle of either one or both of the left side view camera and the right side view camera to capture images in a downward direction of the vehicle, in response to either one or both of the left top view camera and the right top view camera failing.

16. The camera system of claim 10, wherein the electronic controller is further configured to determine that either one or both of the left top view camera and the right top view camera has failed, in response to an image not being received from either one or both of the left top view camera and the right top view camera for a reference time period.

17. (canceled)

18. The camera system of claim 10, wherein the top view camera apparatus further comprises a front top view camera and a rear top view camera.
